(19) United States
(12) Patent Application Publication
(10) Pub. No.: US 2010/0085892 A1
(43) Pub. Date: Apr. 8, 2010

(54) OVERLAY NETWORK COORDINATION REDUNDANCY

(75) Inventor: Ross Kouhi, Ottawa (CA)

Correspondence Address: Kramer & Amado, P.C., 1725 Duke Street, Suite 240, Alexandria, VA, 22314, US

(73) Assignee: ALCATEL LUCENT, Paris (FR)

(21) Appl. No.: 12/246,179

(22) Filed: Oct. 6, 2008

(51) Int. Cl. H04L 12/28

(52) U.S. Cl. 370/254

(57) ABSTRACT

An overlay network coordinator redundancy method and apparatus are disclosed having network coordinator functionality latent in a plurality of application-layer network elements, coupled with a precedence schema provided to all application-layer routers which together provide resiliency and rapid recovery in the event of a hardware failure of the acting overlay network coordinator. The overlay network coordinator redundancy system is particularly useful for overcoming overlay network reliability dependencies upon a single coordinator known in the art.

### CROSS REFERENCE TO RELATED APPLICATIONS

This application is related to a commonly-owned and currently pending application entitled “XML Router and Method of XML Router Network Overlay Topology Creation”, U.S. Ser. No. 11/905,246, filed on Sep. 28, 2007, which is hereby incorporated by reference in its entirety.

### FIELD OF THE INVENTION

The invention relates to overlay network coordinator redundancy and is particularly concerned with overlay network survival upon coordinator loss.

### BACKGROUND OF THE INVENTION

In content-based networks, content is distributed over the network from content providers to content subscribers.

A typical content-based network is constructed with an overlay infrastructure running “atop” a conventional IP (Internet Protocol) network. This overlay infrastructure typically consists of application-layer routers connected to specific nodes in the conventional IP network. Connectivity between the application-layer routers occurs via communication links or hops in the IP network. In general, the content-based network does not have direct paths from all application-layer routers to each and every other application-layer router in the content network. Instead, some application-routers have direct paths to each other and other application-level routers must route content through intermediary application-layer routers to reach a desired destination. The overlay network is topology is defined by which application-layer routers have direct paths to which other application-layer routers in the network under consideration.

As with any network, the procedure used to establish connectivity (or paths) between routers, and the resulting topology, have a profound effect upon network throughput and delay performance. This is true in the instance of overlay network commencement, and in the subsequent instances of further application-layer routers being connected to an existing overlay network.

A scheme for effectively establishing connectivity is therefore needed, and one novel approach is provided by the invention described in the related application. That invention provides a method for adding an application-layer router to an existing content based application-layer network by utilizing XML (eXtensible Markup Language) router discovery and monitoring to manage network element membership, and uses prioritized network metrics (including an application-layer hop metric, an IP cost metric, and a fanout metric) to establish network element adjacency.

The application-layer hops metric assigns an application-layer hops number to each of the existing routers with which the new application-layer router may establish adjacency. The application hops assigned to a potential neighbour application-layer router is the minimum number of application-layer hops (number of application-layer routers traversed) needed to reach the farthest perimeter router from that potential neighbour application-layer router.

The IP cost metric assigns an IP cost to each of the existing routers with which the new application-layer router may establish adjacency. IP cost in general may be measured using any number of possible known IP cost metrics and preferably any IGP (Interior Gateway protocol) metric. In some embodiments of the invention a round trip time for messages to traverse between the new application-layer router and the existing router measured in milliseconds (msec) is used.

The fanout metric assigns a fanout to each of the existing application-layer routers with which the new application-layer router may establish adjacency. The fanout of a router is the number of adjacencies it has established with other application-layer routers of the content-based application-layer network.

In association with metrics are a number of parameters which operator may be set. The first set of parameters is the prioritization parameters. The prioritization parameters are a prioritization of the three metrics discussed above, and a type of fanout prioritization.

When determining the connectivity for a newly added application-layer router, the three metrics are arranged into three ordered priorities and the fanout prioritization type is defined.

The method of the related application in combination with the metrics and priorities may then be utilized by a coordinator function to capture the current state of the application-layer network and provide information to a new application-layer router as to where best to interpose or attach itself within the network. In addition, the coordinator function would also be able to reconfigure the content network in cases of an application-layer router failure by recalculation and provision of information to the surviving application-layer routers as to where best to reconnect if required Other application level routing schemes may use other criteria for the imposing topology, or may use some arbitrary topology assignement scheme.

A potential drawback of such an approach such as the one outlined above if managed by a central coordinator, is the inherent dependency of the content-layer network upon that coordinator function. Loss or disablement of the equipment (typically itself an application-layer router) supporting the coordinator function effectively compromises the content network in terms of adding or removing network elements, or reconfiguring around network element (i.e. application-layer router or possibly IP layer router) failures.

A typical approach for managing resiliency in a coordinating element, or in a traditional client/server architecture is to provide the server or coordinating element with a hot-standby or backup duplicate element. For example, in the domain name server architecture, clients connecting to an IP network have a primary DNS (Domain Name Service) entity and a secondary DNS address. If the primary is unavailable, the secondary can be used. Many other services use a secondary server that runs in duplicate with the primary, so that when failure of the primary is detected, the service can automatically cut over to the hot secondary which is already operating. In both these primary/secondary implementations, there are two entities which divide the risk, but which can still represent a single physical point of failure. For example, if the primary and the standby are co-located geographically, a power outage, or catastrophic event (earthquake, fire, typhoon) can eliminate the service directly.

### SUMMARY OF THE INVENTION

According to one aspect, the invention provides a method for providing coordinator redundancy in an overlay content network having application-layer routers. The method has the steps of providing a coordinator function for determining optional connection points for elaborating the topology of the overlay content network; defining an precedence list of application-routers containing the coordinator function; and contemporaneously to a change to the overlay network; accessing the coordinator function at the application-router highest in precedence on said precedence list; and utilizing the highest in precedence coordinator function in determining the change.

In some embodiments of the invention the application-layer routers are XML routers.

Advantageously, the topology elaboration can consist of adding a new application-layer router to the overlay content network, or alternatively the topology elaboration can consist of reconfiguring the overlay content network path connectivity upon the loss of an existing application-layer router within the overlay content network. In addition, the topology elaboration may consist of reconfiguring the path connectivity of the overlay content network In the event that there is a performance impacting change to the network underlying the overlay content network.

According to another aspect of the invention there is a system for providing a resilient overlay content network having a plurality of application-layer routers; with the application-layer routers connected to an underlying communications network. The application-layer routers are connected to at least one other application-layer router of the overlay content network via a connection path using the underlying communications network, wherein the total set of connection paths between said application-layer routers defines a topology for the overlay content network. A coordinator function for determining optional connection paths for elaborating the topology of the overlay content network is provided, along with a precedence schema defining which subset of the plurality of application-layer routers has the coordinator function latent therein. Further, the precedence schema further defines which application-layer router in the subset of application-layer routers is operating the coordinator function.

The precedence schema may consist of a list of network addresses of application-layer routers of the subset, wherein the list is ordered in terms of precedence.

Advantageously, the elaborating of the topology may be a reconfiguration of the connection paths upon the addition of an application-layer router to the overlay network. Alternatively, the elaborating of the topology could be a reconfiguration of the connection paths upon the loss of an application-layer router in the content overlay network. Further, in the case wherein the application-layer router lost is the application-layer router operating the coordinator function, the precedence schema is used to determine which application-layer router takes over operating the coordinator function for the network.

### BRIEF DESCRIPTION OF THE DRAWINGS

The present invention will be further understood from the following detailed description of embodiments of the invention, with reference to the drawings in which:

FIG. 1 illustrates a known IP network;

FIG. 2 illustrates application-layer routers connected to nodes on the IP network of FIG. 1;

FIG. 3 illustrates an overlay content network in accordance with an embodiment of the present invention comprised of the application-layer routers of FIG. 2;

FIG. 4 illustrates a high-level view of the overlay content network of FIG. 3 highlighting the interconnecting paths between application-layer routers;

FIG. 5 illustrates a block diagram of resident functions in at least a subset of the application-layer routers of an overlay content network in accordance with an embodiment of the present invention; and

FIG. 6 illustrates a precedence list of application-layer routers according to an embodiment of the invention.

It is noted that in the attached figures, like features bear similar labels.

### DETAILED DESCRIPTION

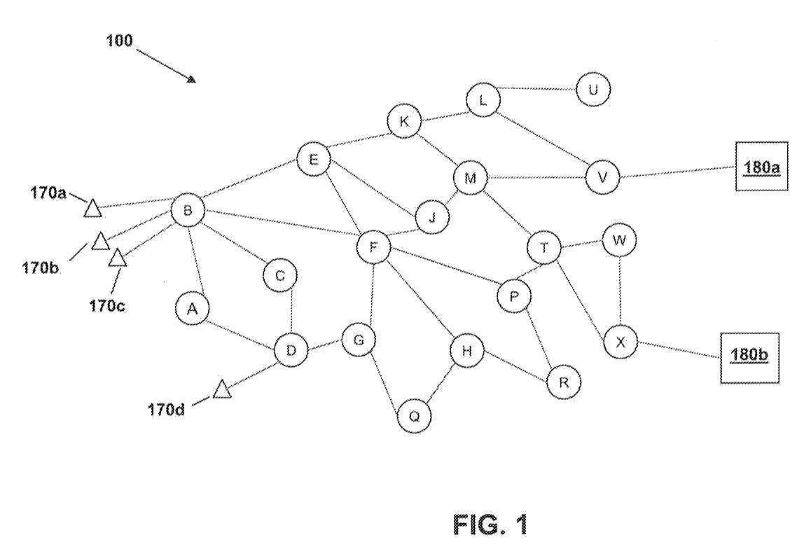

Referring to FIG. 1, there may be seen an illustration of a communications network 100 having network elements A, B, . . . W, X connected by communication paths. Communications network 100 could consist of an IP network, and network elements A, B, . . . W, X would consist of routers within the IP network. FIG. 1 further depicts edge elements 180a and 180b which represent sources or providers of information. Edge elements 170a, 170b, 170c, and 170d represent subscribers or information consumers which have an interest in receiving information from edge elements such as 180a and 180b. It is understood that edge elements may in fact comprise both information provider and subscriber functions as a ‘dual role’ edge element. Single functions are shown here for simplicity.

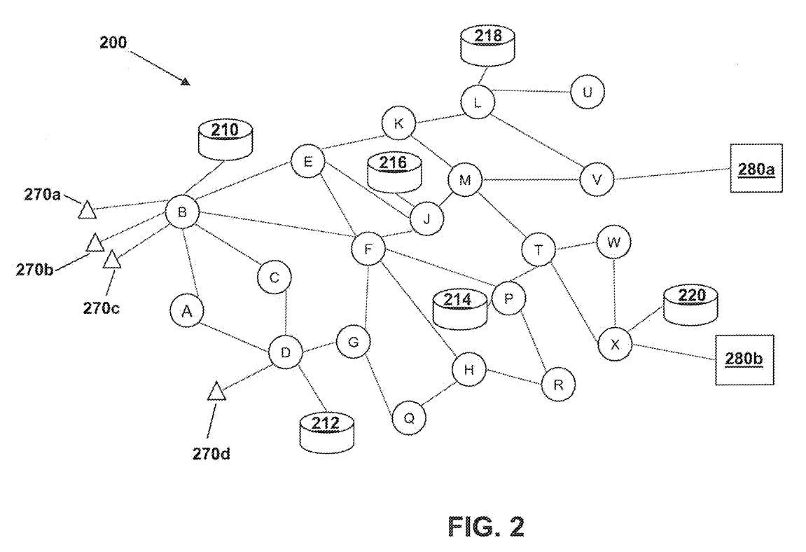

Referring to FIG. 2, within communications network 200 there may be seen additional network elements 210, 212, 214, 218, 218 and 220 representing application-layer routers. These application-layer routers connect to the communications network at specific network elements, namely B, D, P, J, L, and X respectively. Communication between elements 210, 212, 214, 216, 218 and 220 occurs over the underlying communications network 100.

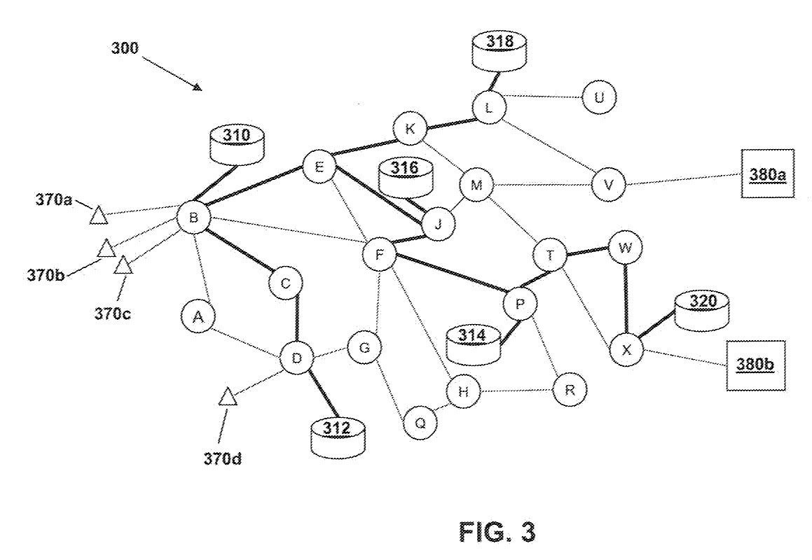

Referring to FIG. 3, there may be seen an overlay communication network 300 consisting of overlay network elements 310, 312, 314, 316, 318 and 320 representing application-layer routers and the communication paths, denoted by thickened lines, over the underlying network connecting the overlay network elements.

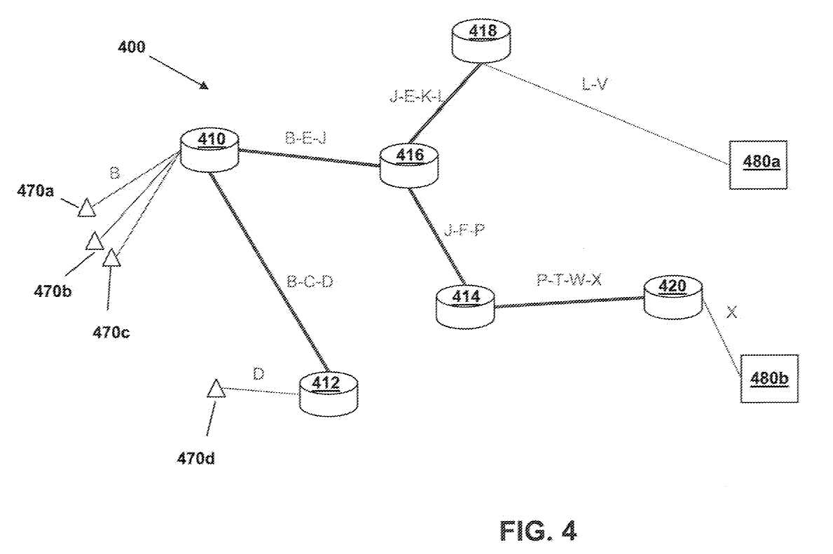

Referring to FIG. 4, there may be seen a simplified depiction of the overlay communications network depicted in FIG. 3 wherein overlay network elements 410, 412, 414, 416, 418 and 420 and their interconnections are depicted. The underlying network elements are denoted by the reference designators adjacent each interconnection.

According to one method of operating an overlay network, there is a coordinator function which resides within one of the overlay network elements. As application-layer routers join or leave the network, this coordinator function maintains a view of the network and coordinates with the application-layer routers as the topology of the network is elaborated. By elaboration is meant such network changes as a new application-layer router joining the network, an existing application-layer network leaving the network; or changes to the underlying network that requires connection path reconfigurations for the elements of the overlay network. In terms of specifics, a newly joining application-layer network element needs to communicate with the coordinator function to determine at least some factors of an optimum connection point or points, verification of credentials, report capabilities, and to reports its decision regarding where it joins the topology if there exist several options. The coordinator function in some implementations also serves as an administrative role, which a management tool may interrogate to gain information about the network.

By way of specific example, an overlay network consisting of application-level XML routers will now be described, and in particular, an example method that a coordinator function may employ in determining optimal connection points for elaborating the overlay network. More particularly, a method for elaborating the network by determining the optimal connection points for adding a new XML router is disclosed.

As discussed previously, topology creation and neighbor discovery are important parts of any routing algorithm, and this is especially true for application overlays. Routers exchange “reachability” information only with discovered neighbors to construct loop-free routing paths that optimize network-wide parameters, such as hops in an IP network. XML routers, which are assumed to be multiple IP hops apart, need to learn about the existence of other XML routers and have a method for choosing a peer. The choice of peers should, in general, take into account application layer parameters (such as fan-out), transport layer metrics (such as TCP (Transmission Control Protocol) hops), and network-layer parameters (such as IP path cost). Of course, some coordinator-managed application layer networks may have non-loop-free architectures. Irregardless, the approach of a centralized coordinator role may still be employed.

XML routers use the TCP/IP suite to communicate with each other. During neighbor discovery, XML routers would communicate via User Datagram Protocol (UDP) through an IP multicast group (inter-autonomous system sparse-mode multicast) to discover each other. Following discovery, XML routers use the hereafter disclosed topology construction algorithm to choose peers. Once the XML overlay is constructed, publish/subscribe XML message routing may proceed within the overlay using TCP to guarantee message delivery. Alternatively, neighbors can use mechanisms other than multicasting, such as a central database, to discover each other.

In the following description, XML routers rely on lower layer protocols for message delivery thus reducing the XML router control plane complexity. It is also presumed that IGP (Interior Gateway Protocol) and BGP (Border Gateway Protocol) are responsible for fault-recovery at, and below, the network layer and TCP is responsible for message delivery between XML routers.

Producers and consumers using the overlay content network are allowed to register with any XML router. Once registered, for a given producer or consumer, all future communication takes place only through this (designated) XML router. The overlay network of XML routers is responsible for routing, filtering and matching producer/consumer publications and subscriptions.

The following XML-routed network topology construction algorithm takes into consideration a priority-based set of metrics and parameters. These metrics include network layer cost groups (IP path cost), a transport cost metric (TCP hops), and an application cost metric (fan-out). As the XML router devices function at the application level, this method aggregates selected underlying network-layer cost metrics into a composite network-cost metric. Performance parameters such as delays, IGP costs, and BGP costs are abstracted into a single composite network-cost. Network layer cost groups are created by grouping IP costs to reach potential XML router peers into sets of IP cost ranges for coarse granularity. The method considers network layer cost groups in ascending order for peer selection. The difference between IP costs within a group is not considered by the method. The number of application level hops (TCP hops) from a source XML producer to a destination XML consumer in the overlay network is the transport cost metric. The transport cost represents a count of XML routers, not IP routers, from source to destination. The maximum transport cost (TCP hops) in a network represents XML network diameter and measures TCP hops between the farthest separated XML routers in the overlay network. The application cost metric, or fan-out of an XML router, is the count of peer XML neighbor routers.

According to one embodiment, each needs to be pre-configured with relative metric priorities between network cost groups, transport cost and application cost (fan-out), along with settings of the ranges for the network cost groups and maximum fan-out limit allowed by the message-replication power of the XML router. Such settings may be manual or via a policy. An XML router is interested in finding a potential neighbor with the lowest maximum transport cost, and highest fan-out, within the lowest network cost group according to these metrics' relative priorities as explained below.

Independently, the chosen parameters are potentially insufficient to provide consistent guidance for topology formation. That is, a two TCP hop path may occasionally be more efficient than a one hop path due to differences in network cost group metrics of the two paths. A multi-parameter algorithm provides the intelligence and flexibility to achieve optimal topology.

By way of example, let WT be the set of all online connected XML routers and P1, P2, and P3 the relative metric priorities. P1 being higher priority than P2, which is higher than P3. Calculations for a new XML router to join the network of WT XML routers may be done by following the steps below:
1. Hello messages are sent periodically to WT through IP multicast for XML router discovery.
2. Connectivity descriptor messages are exchanged using unicast (TCP) between the new XML router and WT XML routers.
3. Connectivity descriptor messages contain individual XML router's maximum TCP hops and fan-out information.
4. The new XML router calculates the network layer cost from message delay tests, IGP cost, and optionally, BGP metrics, and populates the network cost groups table.
5. A database of WT XML routers is built containing each XML router's network cost, transport cost and fan-out excluding the XML routers that have achieved their maximum fan-out.
6. The database is checked to find an XML router peer according to P1.
7. If more than one potential XML router peer satisfies P1, say the WP1 subset of WT, then WP1 is checked according to P2.
8. If more than one potential XML router peer satisfies P2, say the WP2 subset of WP1, then WP2 is checked according to P3.
9. If more than one potential XML router peer satisfies P3, say the WP3 subset of WP2, then WP3 is checked for least IP cost
10. If more than one router has an equal least IP cost, then the tie is broken by joining the XML router with highest XML router identity.

Note that the network cost is initially determined when an XML router joins the partial network of XML routers. However, the network cost group metric is typically dynamic and can change over time. To deal with variance in the network cost group metrics towards other XML routers, a coordinator may reassess the metrics for all other routers at random times within a topology-evaluation time period. If metrics reassessment results in a more desirable topology than the current one, topology changes can be implemented in a make-before-break sequence to avoid XML document loss.

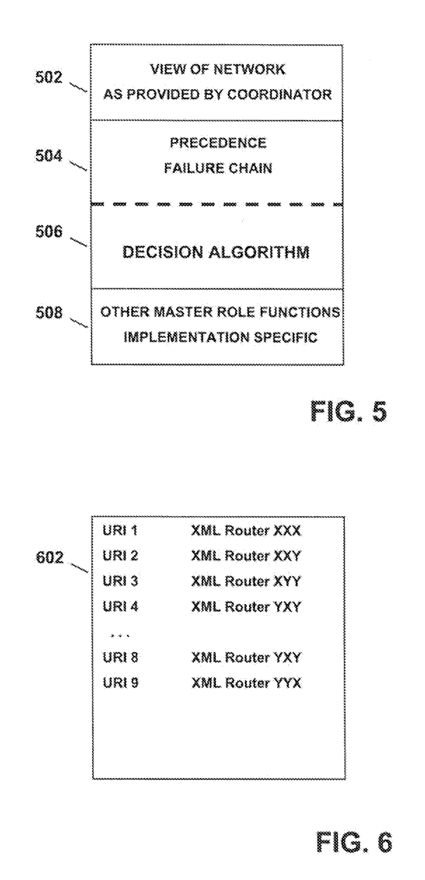

According to an embodiment of the invention the coordinator function may be placed in a subset, up to and including all, of the application layer routers. Referring to FIG. 5 there may be seen a table diagramming the functions which would be resident in the application-layer routers which have the coordinator function placed therein. At the top level there may be seen a view of the network 502, which is a representation of the overlay network. Following this, exists a precedence failure chain 504 which represents a listing of overlay network elements which contain a copy of the coordinator function, and which also represents the order in which the coordinator function is deemed to be active should failures occur.

This precedence failure chain is established according to a precedence schema. This may be a listing of overlay network elements according to some specific criteria, such as server role intensity wherein overlay elements with more operational capacity are preferred over those elements with less capacity. Alternatively it may consist of a schema wherein the overlay element containing the coordinator function and with the lowest or highest network address is the next network element to assume the active coordinator role in the event of a loss of the existing coordinator. A further schema may involve a preferential listing which is a function of the particular software release resident in the network element, with network elements containing more recent releases placed in a preferential position over those elements with more dated software. An example of a precedential list of may be seen at 602 in FIG. 6.

Returning to FIG. 5, there may be seen a set of coordinator functions 506 and 508 which are depicted below the hashed line in the diagram. These functions are latent in those network elements which are not currently providing the coordinator function. At 506 there is represented a functional block representing the decision algorithm (an example of which was given in the foregoing description above) which determines the optimum point or points at which to add a network element as the overlay network is elaborated. Of course, such a decision algorithm would also be used to reconfigure the network in case of loss of an existing overlay network element, or in the case of a loss of network elements in the underlying network that serve to connect the elements of the overlay network. At 508 there is represented a functional block containing other master coordinator functionality, such as credential handling, capability acknowledgment, or other administrative functions.

According to this embodiment, any overlay network element containing a copy of the coordinator function may be “anointed” the active coordinator and will perform coordination functions for the overlay network. Secondary, tertiary, etc. backup coordinators are defined in an ordered succession plan via the precedence schema and captured in the precedence failure chain. As may be readily understood, when the active coordinator fails, subsequent network elements assume the active role, and update the precedence list for all the other network elements.

The result of the described implementation is a more resilient network, where recovery from multiple failures can be managed.

With the resilient coordinator architecture described in the above embodiments, there is no extra physical entity required in the overlay network to support the coordinator function. A network administrator would provision new overlay network elements with the precedence failure chain and the new element would coordinate with the active coordinator to join the network. The active coordinator would proceed to coordinate the elaboration of the network with the addition of the new element, and if it were to also be capable of supporting coordinator functionality, it would be added to the precedence failure chain via the precedence schema and the results propagated throughout the overlay network.

As will be recognized by those skilled in the art, numerous modifications, variations and adaptations may be made to the embodiment of the invention described above without departing from the scope of the invention, which is defined in the claims.

What is claimed is:

1. A method for providing coordinator redundancy in an overlay content network having application-layer routers, said method comprising the steps of:
providing a coordinator function for determining optional connection points for elaborating the topology of said overlay content network;
defining an precedence schema of application-routers containing said coordinator function;
and contemporaneously to a change to the overlay network;
accessing the coordinator function at the application-router highest in precedence as established by said precedence schema; and
utilizing said highest in precedence coordinator function in determining said change.

2. The method of claim 1, wherein said precedence schema is an ordered list.

3. The method of claim 2, wherein said precedence list contains at least three application-layer network elements.

4. The method of claim 1, wherein said precedence schema is based upon the network addresses of said application-layer routers.

5. The method of claim 1, wherein said elaborating comprises adding a new application-layer router to the overlay content network.

6. The method of claim 1, wherein said elaborating comprises reconfiguring the overlay content network upon the loss of an application-layer router of the overlay content network.

7. The method of claim 1, wherein said elaborating comprises reconfiguring said overlay content network upon a performance impacting loss of a network element of a network underlying the overlay content network.

8. A system for providing an overlay content network, comprising;
a plurality of application-layer routers;
said application-layer routers connected to an underlying communications network;
said application-layer routers connected to at least one other application-layer router of the overlay content network via a connection path using said underlying communications network, wherein the total set of connection paths between said application-layer routers defines a topology for the overlay content network;
a coordinator function for determining optional connection paths for elaborating the topology of the overlay content network;
a precedence schema defining which subset of said plurality of application-layer routers has the coordinator function latent therein; and
said precedence schema further defining which application-layer router in said subset of application-layer routers is operating said coordinator function.

9. A system for providing an overlay content network as claimed in claim 8, wherein said precedence schema comprises a list of network addresses of application-layer routers of said subset, and the list is ordered in terms of precedence.

10. A system for providing an overlay content network as claimed in claim 8 wherein the elaborating of the topology comprises a reconfiguration of the connection paths upon the addition of an application-layer router to the overlay network.

11. A system for providing an overlay content network as claimed in claim 8 wherein the elaborating of the topology comprises a reconfiguration of the connection paths upon the loss of an application-layer router in the content overlay network.

12. A system for providing an overlay content network as claimed in claim 11 wherein when the application-layer router lost is the application-layer router operating said coordinator function, said precedence schema is used to determine which application-layer router takes over operating said coordinator function.
